(19) United States
(12) Patent Application Publication
(10) Pub. No.: US 2003/0026551 A1
(43) Pub. Date: Feb. 6, 2003

(54) Optical fiber connector

(76) Inventor: Larry Kwung Tan, Cupertino, CA (US)

Correspondence Address: S. Alex Liao, Suite 905, 12 S. First St., San Jose, CA, 95113, US

(21) Appl. No.: 09/924,090

(22) Filed: Aug. 6, 2001

(51) Int. Cl. G02B 6/36

(52) U.S. Cl. 385/78; 385/86

(57) ABSTRACT

The optical fiber connector according to the present invention has an optical fiber with an expanded center core at the free end of the fiber. The optical fiber is securely attached within the center bore of the ferrule. The ferrule has a front end and a rear end. The front end of the ferrule makes contact with another optical connector. The rear end of the ferrule is housed within a connector body. The free end of the optical fiber with the expanded center core is exposed at the front end of the ferrule, where a contact is made with another optical connector. The optical fiber connector has a typical structure, except for the expanded center core, including a ferrule, a connector body, strain relief boot, and a cable protecting the optical fiber outside the connector.

### BACKGROUND OF THE INVENTION

1. Field of Invention

The present invention relates to an optical connector for connecting optical fibers to each other.

2. Description of the Related Art

Optical connectors connecting optical fibers to each other are commonly used in the fiber optic industries. Most optical connectors used today share some common elements or features. For example, the optical fiber is affixed through a center hole of a ferrule, which is a long and thin cylinder. The size of the center hole of the ferrule matches the diameter of the cladding of the fiber. An end of the fiber is exposed on the surface of the front end of the ferrule. The front end of the ferrule and the exposed fiber end are polished to a smooth condition. The ferrule may then be inserted into a connector body that serves to protect the ferrule and fiber from mechanical damages.

Standard fiber optical connectors do not have the male-female polarity commonly used in electronic connectors. Rather, optical connectors mate in adaptors commonly called coupling receptacles or sleeves, which are placed between two optical connectors. Each connector meets at its front end of ferrule inside the adapter.

The diameter of the fiber ranges from 124 μm to 127 μm. The typical structure of the fiber consists of cladding with a light transmitting center core. The main function of the center core is to transmit light signals and the core is about 9 μm in diameter. Because of the small diameter of the center core, it is crucial that the center core of the fiber in each ferrule completely aligns with each other within the adapter in order to reduce any potential loss of optical power while connecting the two connectors together. Factors contributing misalignment of the two optical connectors include variation of the ambient temperature or mishandling the connectors during operation.

Therefore, there is need to increase the transmission efficiency and to reduce the potential loss of power at the connecting point of the connectors.

### SUMMARY OF THE INVENTION

It is therefore an object of the invention to provide an optical connector, having a higher transmission efficiency and less loss of optical power being transmitted.

It is therefore another object of the present invention to provide an optical connector having an optical fiber with an expanded light transmitting center core.

According to the present invention, an optical connector comprising an optical fiber having an end portion, said fiber having a light transmitting center core, said center core having an expanded portion at said end portion; a ferrule having a center bore, a front end and a rear end, said fiber passing through said rear end and securely affixed within said bore, whereby said end portion of said fiber is exposed at said front end of said ferrule; and a connector protective housing means for supporting and protecting said ferrule and said fiber outside of said ferrule.

Said center core has a first diameter of about 9 μm and said expanded portion has a diameter larger than the first diameter. The diameter of the expanded center core can reach between 20 μm to 30 μm. Said expanded portion of said fiber is formed by heating said end portion of said fiber at a temperature of about 1000 degree Celsius.

Said connector protective housing means of said optical connector further comprising a strain relief housing, a connector body, and a cable, whereby said ferrule is securely attached inside said connector body. Said cable connects to the other end of said ferrule and houses the portion of said fiber outside of said ferrule.

### BRIEF DESCRIPTION OF THE DRAWINGS

FIG. 1 is a diagram showing a typical structure of an optical connector and the sleeve.

FIG. 2 is a cross-section of an optical fiber showing the light-transmitting center.

FIG. 3 summarizes the process of making an optical fiber with an expanded center core at the free end of the fiber.

### DETAILED DISCRIPTION OF THE PREFERRED EMBODIMENTS

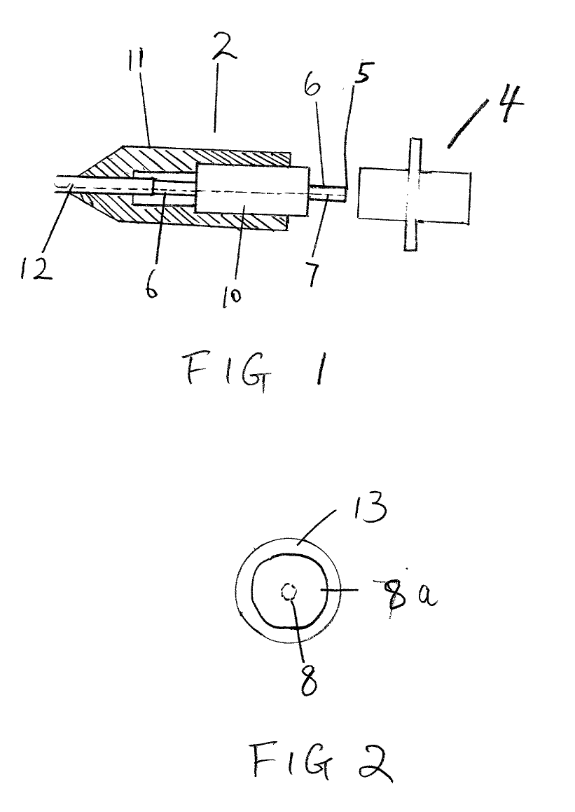

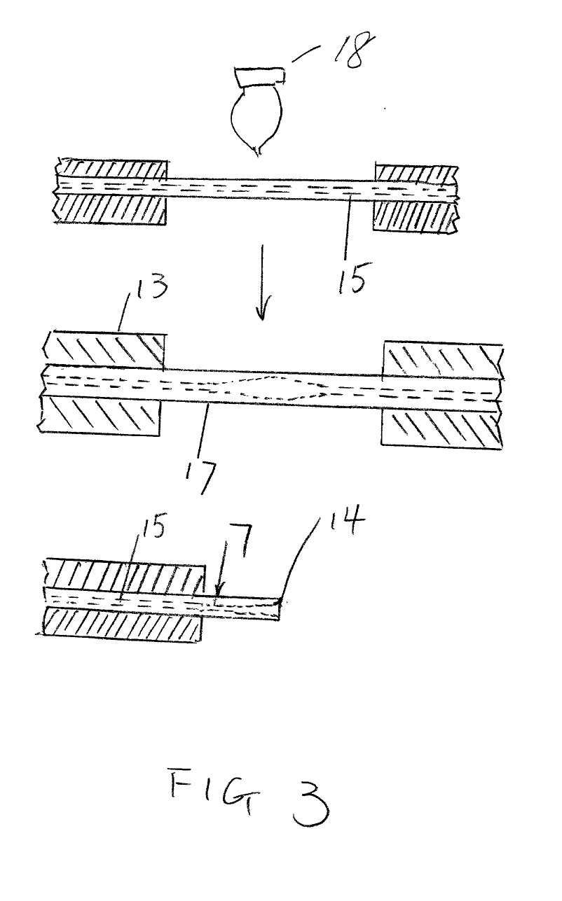

Referring to FIG. 1, a typical structure of an optical connector 2 and a receptacle 4 are shown. The connector 2 consists of a ferrule 6, through which an optical fiber 7 passes. A typical optical fiber 7 has a light transmitting center core 8, cladding 8a, and a protective coating 13 (FIG. 2). A ferrule 6 has a center bore that has a diameter of the fiber 7 without the protective coating 13. The optical fiber 7 (FIG. 1) is securely attached inside the center bore of the ferrule 6. The ferrule 6 has an outside end 5 exposed for connecting another optical fiber connector. The ferrule 6 passes through a connector body 10 and both ends of the ferrule 6 protrude from the connector body 10. A strain relief boot 11 encases the connector body 10 and the ferrule 6 therein. A protective cable 12 connects the inside end of ferrule 6 and extends out of the strain relief boot 11 for protecting the fiber 7.

According to the preferred embodiment of the present invention, a single mode optical fiber 7, such as Coming SMF28, is stripped of its protective coating to expose about 1 inch long bare fiber portion 17 (FIG. 3). The bare fiber portion 17 is heat-treated by a TEC thermal process 18 well known in the industry at the temperature about 1,000 degrees Celsius. After the thermal treatment, the center core 15 at the heated portion will be expanded from a diameter of 9 μm up to a diameter of about 30 μm. The bare fiber portion 17 is cut into half, which yields a free end 14 at the bare fiber 17. Epoxy is then applied on the bare fiber portion 17 and the free end 14 of bare fiber potion 17 is inserted into the center bore of the ferrule 6 in a pre-assembled connector 2. The bare fiber portion 17 will be securely attached inside the center bore of the ferrule 6. Excessive fiber 17 at the outside end 5 of the ferrule 7 is cut off. The surface of the outside end 5 of ferrule 7 is polished into a smooth connection surface with the free end 14 of the bare fiber portion 17 exposed in the center bore of the ferrule.

According to the present invention, the expanded fiber 7 can handle higher transmission optical power, up to few watts than conventional fiber optic connectors, such as FC/PC, FC/SPC types. While the invention has been disclosed in details above, the invention is not intended to be limited strictly to the invention as disclosed. It is apparent that those skilled in the art may presently make many uses and modifications described herein without departing from the inventive concepts.

What is claimed is:

1. An optical connector comprising
an optical fiber having an end portion, said fiber having a light transmitting center core, said center core having an expanded portion at said end portion;
a ferrule having a center bore, a front end and a rear end, said fiber passing through said rear end and securely affixed within said bore, whereby said end portion of said fiber is exposed at said front end of said ferrule; and
a connector protective housing means for supporting and protecting said ferrule and said fiber outside of said ferrule.

2. An optical connector according to claim 1, wherein said optical fiber has a diameter in the range of 124 μm to 127 μm.

3. An optical connector according to claim 1, wherein said center core has a first diameter of about 9 μm and said expanded portion has a second diameter larger than said first diameter.

4. An optical connector according to claim 3, wherein said second diameter is between 20 μm to 30 μm.

5. An optical connector according to claim 4, wherein said expanded portion is formed by heating said end portion of said fiber at a temperature of about 1000 degree Celsius.

6. An optical connector according to claim 5, wherein said front end of said ferrule has a polished face and said expanded end portion of said fiber is polished and flattened at said polished face of said front end of said ferrule.

7. An optical connector according to claim 6, wherein said ferrule is made of metal, ceramic, or plastic.

8. An optical connector according to claim 1, wherein said connector protective housing means further comprising
a strain relief housing having a front open end and a rear open end;
a connector body having a front open end, a rear open end, and a center bore, whereby said ferrule is securely attached in said center bore of said connector body and said front end of said ferrule is protruding from said front end of said connector body and said rear end of said ferrule is protruding from said rear end of said connector body within said connector housing; and
a cable housing a portion of said fiber outside of said ferrule, whereby one end of said cable is securely attached to said rear end of said ferrule and said cable is securely attached to said connector housing within said connector housing, whereby said cable extends into said strain relief housing through said rear end of said strain relief housing.
